(19) United States
(12) Patent Application Publication
(10) Pub. No.: US 2011/0174275 A1
(43) Pub. Date: Jul. 21, 2011

(54) Fuel Supply System

(75) Inventors: JongKeun LIM, Cheongju-si (KR); Inseok SOHN, Cheongju-si (KR); Kyuseob SHIN, Daejeon (KR); Joonseup KIM, Daejeon (KR); Munsik JEON, Cheongju-si (KR)

(73) Assignee: COAVIS, Chungcheongnam-do (KR)

(21) Appl. No.: 13/007,081

(22) Filed: Jan. 14, 2011

(30) Foreign Application Priority Data
Jan. 15, 2010 (KR) 10-2010-0003768

(51) Int. Cl. F02M 37/04; F02M 37/00

(52) U.S. Cl. 123/509; 123/514

(57) ABSTRACT

Provided is a fuel supply system. The fuel supply system includes a fuel pump module mounted in a fuel tank and including a reservoir having a predetermined amount of fuel filled therein and a fuel pump mounted in the reservoir to suck the fuel filled in the reservoir and supply it to an internal combustion engine; a fuel supply line supplying fuel from the fuel pump module to the internal combustion engine; and a fuel return line returning the fuel from the internal combustion engine to the fuel tank, wherein the inside of the reservoir is provided with a bypass tube connecting the fuel return line to the fuel pump to directly supply the fuel returned through the fuel return line to the fuel pump through the bypass tube.

### CROSS-REFERENCE TO RELATED APPLICATIONS

This application claims priority under 35 U.S.C. §119 to Korean Patent Application No. 10-2010-0003768, filed on Jan. 15, 2010 in the Korean Intellectual Property Office, the disclosure of which is incorporated herein by reference in its entirety.

### TECHNICAL FIELD

The present invention relates to a fuel supply system capable of supplying fuel to an internal combustion engine and returning fuel from the internal combustion engine to a fuel tank, and more particularly, to a fuel supply system capable of directly supplying the remaining fuel after fuel from which foreign materials are removed by various filters during the supply of fuel is used in an internal combustion engine to a fuel filter to supply more clean fuel to the internal combustion engine and using the returned fuel as a working fluid during the supply of fuel to increase the durability of a fuel pump.

### BACKGROUND

Generally, vehicles using fluid fuel such as gasoline, diesel, or the like, have a fuel supply system that supplies fuel from a fuel tank 100 storing fuel to an internal combustion engine 160 and returns the remaining fuel after used in the internal combustion engine 160 to the fuel tank 100.

FIGS. 1 to 6 are diagrams schematically showing various types of fuel supply systems according to the related art. As shown in FIGS. 1 to 6, the fuel tank 100 is provided with a fuel pump module 110 that sucks fuel filled in the fuel tank and supplies it to the internal combustion engine 160, wherein the fuel pump module 110 is connected to the internal combustion engine 160 through a fuel supply line 140 to supply the fuel sucked into the fuel pump module 110 to the internal combustion engine 160 and combust it therein, thereby providing a driving force.

As described above, the fuel supplied to the internal combustion engine 160 returns the remaining fuel after a predetermined amount of fuel is used in the internal combustion engine 160 to the fuel tank 100 through a fuel return line 150 connected to the fuel tank 100.

The fuel pump module 110 mounted in the fuel tank 100 and supplying fuel to the internal combustion engine 160 is configured to include a reservoir 115 having a predetermined amount of fuel filled therein to stably supply fuel even in the state where a vehicle is inclined or a low fuel state and a fuel pump 111 provided in the reservoir 115 and sucking fuel filled in the reservoir 115 and supplying it to the internal combustion engine 160.

The internal combustion engine 160 is a device that combusts fuel supplied from the fuel pump module 110 to obtain a driving force and varies the used amount of fuel according to travelling conditions, road conditions, and driving habits of a driver, such that the fuel amount supplied to the internal combustion engine 160 through the fuel pump module 110 generally exceeds the maximum usage of the internal combustion engine 160.

As described above, the fuel exceeding the usage of the internal combustion engine 160 is returned to the fuel tank 100 through the fuel return line 150 connected to the fuel tank 100 and some of the fuel is re-supplied to the internal combustion engine 160 through the fuel pump module 110 to be re-circulated.

However, among fuel from which foreign materials are removed by various filters during the supply of fuel, returned clean fuel exceeding the usage of the internal combustion engine 160 is mixed with fuel that is not filtered. As such, the fuel supply system according to the related art again filters the fuel mixed with foreign materials and supplies it to the internal combustion engine 160, which is inefficient.

In order to solve the problem, as shown in FIGS. 4 to 6, the fuel return line 150 to which fuel is returned is connected to the reservoir 115 of the fuel pump module 110.

As a result, as shown in FIGS. 1 to 3, the filtering efficiency is increased when considering the amount of returned fuel to the fuel tank 100; however, since the fuel, which is not filtered, is still filled in the reservoir 115, it is difficult to expect a large effect.

The problem is largely raised in antiquated vehicles having a large amount of foreign materials included in the fuel tank 100 thereof or vehicles using similar fuel or low-quality fuel and is more serious in countries in which the development of refinery technology of fuel is slow, such as Brazil, India, China, Russia, etc.

### SUMMARY

An object of the present invention is to provide a fuel supply system capable of re-supplying clean fuel returned from an internal combustion engine to the internal combustion engine.

Another object of the present invention is to provide a fuel supply system capable of reducing trouble of an internal combustion engine and improving fuel efficiency by supplying more clean fuel to the internal combustion engine.

Still another object of the present invention is to provide a fuel supply system capable of increasing the durability of a fuel pump while increasing the durability of a primary filter by introducing a fluid, i.e., mostly filtered fuel into the fuel pump to reduce a flux sucked into the primary filter.

According to an exemplary embodiment of the present invention, there is provided a fuel supply system, including: a fuel pump module mounted in a fuel tank and including a reservoir having a predetermined amount of fuel filled therein and a fuel pump mounted in the reservoir to suck the fuel filled in the reservoir and supply it to an internal combustion engine; a fuel supply line supplying fuel from the fuel pump module to the internal combustion engine; and a fuel return line returning the fuel from the internal combustion engine to the fuel tank, wherein the inside of the reservoir is provided with a bypass tube connecting the fuel return line to the fuel pump to directly supply the fuel returned through the fuel return line to the fuel pump through the bypass tube.

According to another exemplary embodiment of the present invention, there is provided a fuel supply system, including: a fuel pump module mounted in a fuel tank and including a reservoir having a predetermined amount of fuel filled therein and a fuel pump mounted in the reservoir to suck the fuel filled in the reservoir and supply it to an internal combustion engine; and a fuel supply line supplying fuel from the fuel pump module to the internal combustion engine, the fuel supply system including: a fuel return line included in the fuel tank and returning fuel from the fuel supply line to the reservoir; and a bypass tube disposed in the reservoir and connecting the fuel return line with the fuel pump, wherein the fuel returned through the fuel return line is directly supplied to the fuel pump through the bypass tube.

The bypass tube may be connected to a fuel inlet of the fuel pump.

The fuel inlet of the fuel pump may be provided with a primary filter and the bypass tube may be connected to the rear end of the primary filter.

The fuel supply line may be provided with a secondary filter.

At least one secondary filter may be provided at a point selected from the outside of the fuel tank, the inside of the fuel tank, and the inside of the reservoir.

The fuel return line or the bypass tube may be provided with a regulator.

Other features and aspects will be apparent from the following detailed description, the drawings, and the claims.

### BRIEF DESCRIPTION OF THE DRAWINGS

FIG. 1 is a diagram schematically showing an A-type fuel supply system according to the related art;

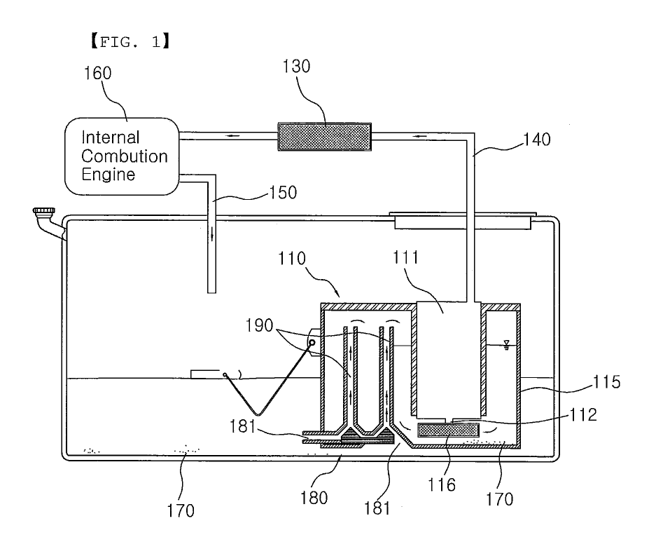

FIG. 2 is a diagram schematically showing a B-type fuel supply system according to the related art;

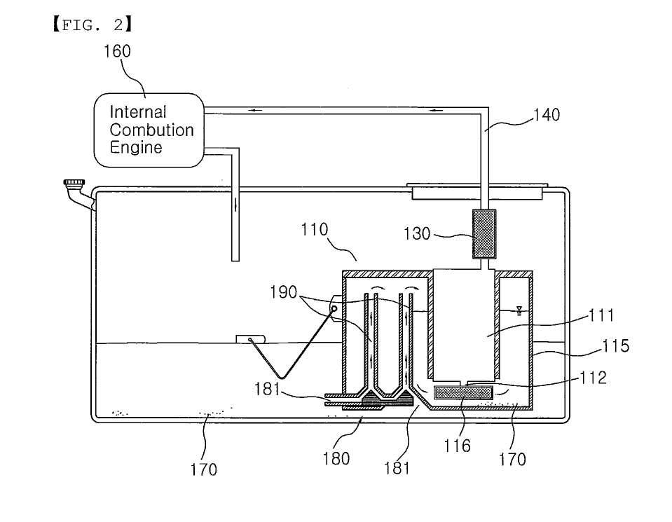

FIG. 3 is a diagram schematically showing a C-type fuel supply system according to the related art;

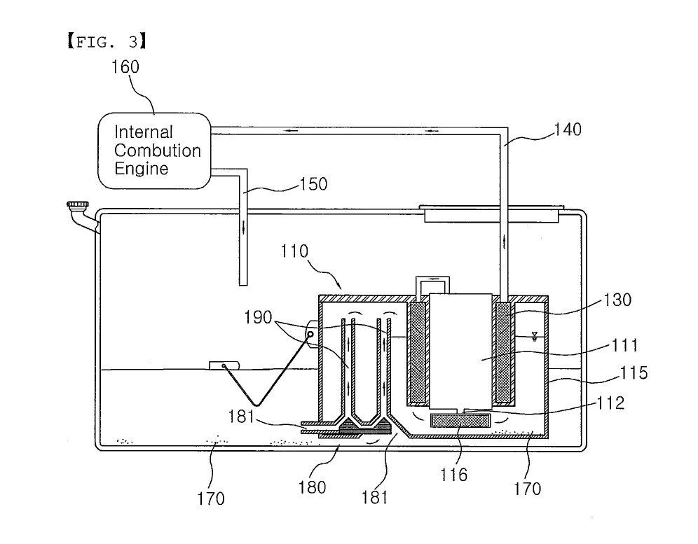

FIG. 4 is a diagram schematically showing a D-type fuel supply system according to the related art;

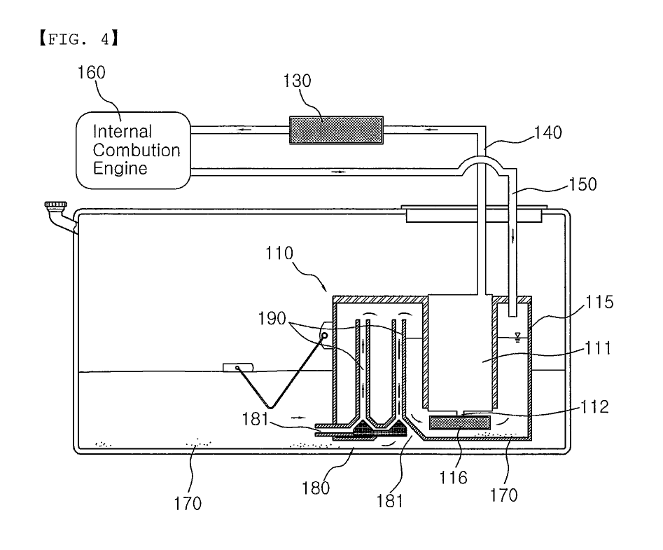

FIG. 5 is a diagram schematically showing an E-type fuel supply system according to the related art;

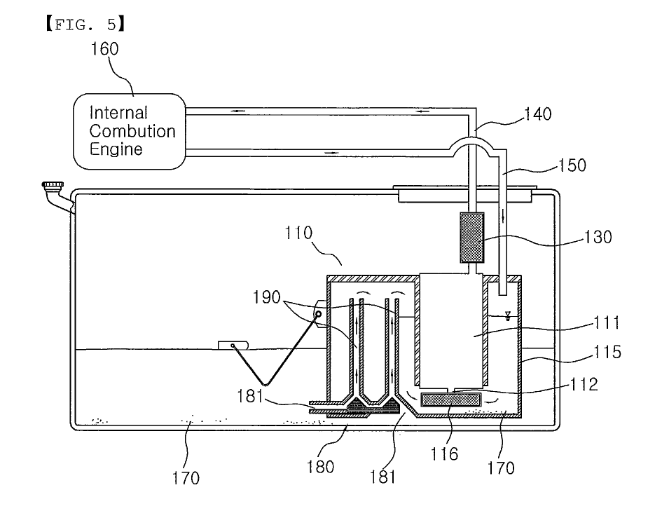

FIG. 6 is a diagram schematically showing an F-type fuel supply system according to the related art;

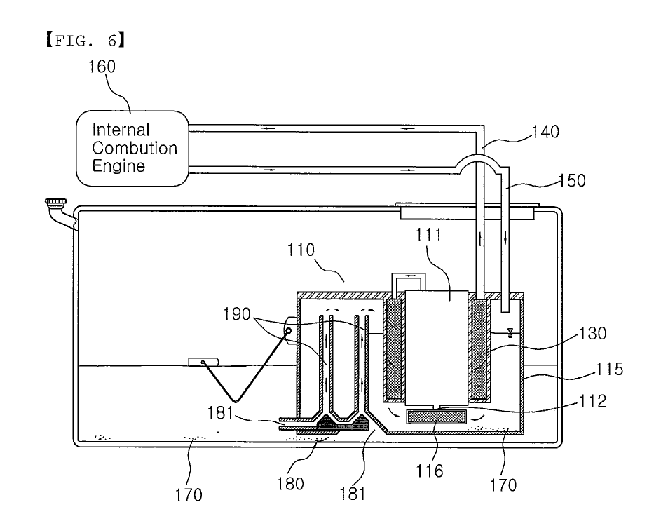

FIG. 7 is a diagram schematically showing an A-type fuel supply system according to the present invention;

FIG. 8 is a diagram schematically showing a B-type fuel supply system according to the present invention;

FIG. 9 is a diagram schematically showing a C-type fuel supply system according to the present invention;

FIG. 10 is a diagram schematically showing a D-type fuel supply system according to the present invention;

FIG. 11 is a diagram schematically showing a E-type fuel supply system according to the present invention;

FIG. 12 is a diagram schematically showing a F-type fuel supply system according to the present invention; and

FIG. 13 is a partially enlarged view showing another exemplary embodiment of a fuel supply system according to the present invention.

### DETAILED DESCRIPTION OF EMBODIMENTS

The advantages, features and aspects of the present invention will become apparent from the following description of the embodiments with reference to the accompanying drawings, which is set forth hereinafter.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, a fuel supply system having the above-mentioned components will be described with reference to the accompanying drawings.

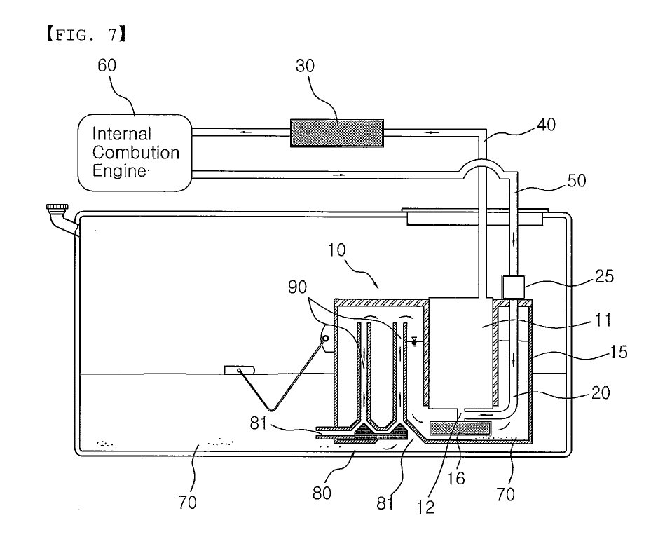

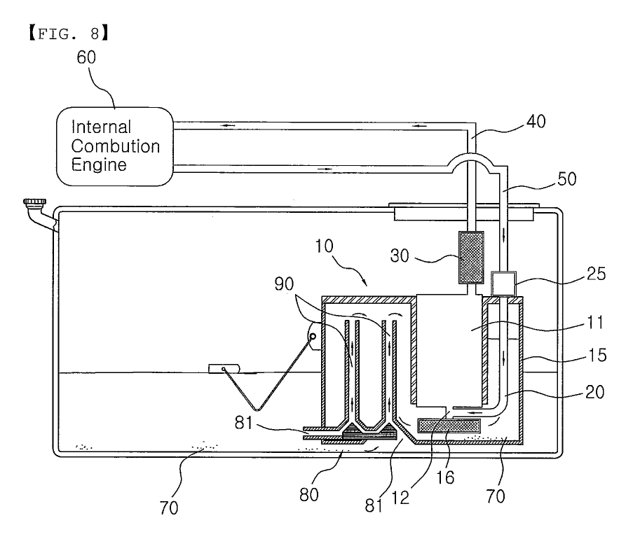

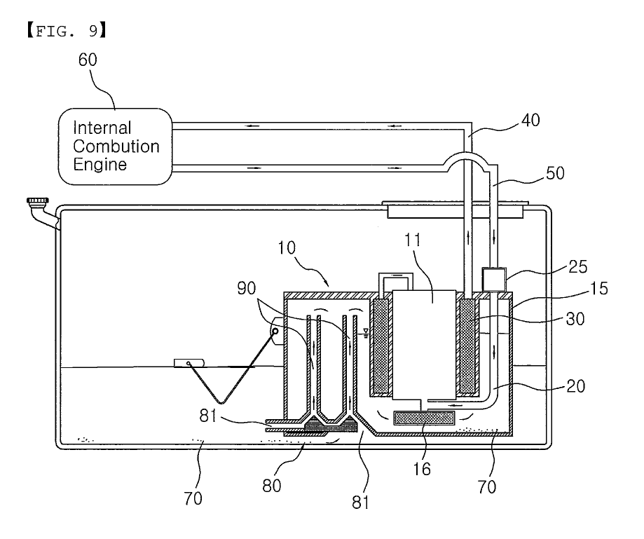

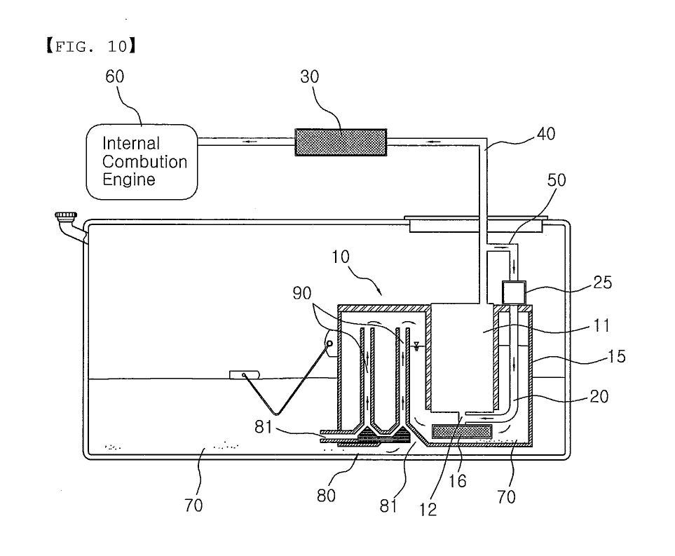

FIG. 7 is a diagram schematically showing an A-type fuel supply system according to the present invention, FIG. 8 is a diagram schematically showing a B-type fuel supply system according to the present invention, FIG. 9 is a diagram schematically showing a C-type fuel supply system according to the present invention, and FIG. 10 is a diagram schematically showing a D-type fuel supply system according to the present invention.

FIGS. 7 to 9 show a fuel supply system having various shapes according to a position of a secondary filter 30 mounted on a fuel supply line 40 supplying fuel from a fuel tank 100 to an internal combustion engine 60. As shown in FIGS. 7 to 9, the fuel supply system of the present invention is configured to include a fuel pump module 10 mounted in the fuel tank 100 stored with fuel to suck the fuel within the fuel tank 100 and uniformly supply the fuel to the internal combustion engine 60, a fuel supply line 40 connected to the fuel pump module 10 to move the fuel to the internal combustion engine 60, and a fuel return line 50 connected to the fuel pump module 10 to which remaining fuel after using the fuel is returned from the internal combustion engine 60.

The fuel pump module 10, which is mounted in the fuel tank 100 to forcibly suck fuel stored in the fuel tank and supply it to the internal combustion engine 60, serves to smoothly supply fuel to the internal combustion engine 60 even in the state where a vehicle is inclined according to road conditions and travelling conditions or even in the state where the amount of fuel stored in the fuel tank is small, i.e., a low fuel state.

As shown in FIGS. 7 to 9, the fuel pump module 10 is configured to include a container-shaped reservoir 15 in which a predetermined amount of fuel is filled in order to meet variable travelling conditions of a vehicle and road conditions and a fuel pump 11 mounted in the reservoir 15 to forcibly suck the fuel filled in the reservoir 15 and supply it to the internal combustion engine 60, wherein the fuel pump 11 is adjacently mounted to the bottom surface of the fuel tank 100 in order to easily suck the fuel stored in the fuel tank 100.

The components and operation of the fuel pump module 10 will be described in more detail. The reservoir 15 configuring the fuel pump module 10, which is a storage container first storing a predetermined amount of fuel, includes a jet pump 80 that first stores the fuel stored in the fuel tank 100 in the reservoir 15.

The jet pump 80 serves to suck the fuel into the fuel tank 100 by the fuel jet sprayed from the jet pump 80 by quickly spraying the fuel into the reservoir 15, thereby first filling the fuel into the reservoir 15.

The fuel amount filled in the reservoir 15 is formed at a predetermined height so that a proper amount of fuel overfills at all times in consideration of the maximum fuel consumption of a vehicle and the fuel sucked by the fuel jet of the jet pump 80 that exceeds a height of a guide tube 90 formed to be vertically extended to the jet pump 80 and then, fills the fuel in the reservoir 15.

The jet pump 80 is adjacently disposed to the bottom surface of the fuel tank 100, which serves to first supply sufficient fuel to the reservoir 15 even though the fuel of the fuel tank 100 is a low fuel state, thereby making it possible to smoothly supply the fuel to the internal combustion engine 60.

The fuel pump 11 included in the reservoir 15 is electrically consecutively operated from the time when the internal combustion engine 60 starts to suck the fuel in the reservoir 15 into an fuel inlet 12 at the bottom side thereof and uniformly supply the fuel to the internal combustion engine 60.

As described above, the fuel pump module 10 is connected to the internal combustion engine 60 through the fuel supply line 40 supplying fuel to the internal combustion engine 60 and the fuel supply line 40 is provided with the secondary filter 30 to remove foreign materials 70 included in the fuel during the supply of fuel and supply more clean fuel to the internal combustion engine 60.

The secondary filter 30 included in the fuel supply line 40 serves to remove the foreign materials 70 included in the fuel to supply more clean fuel to the internal combustion engine 60. As shown in FIG. 7, the secondary filter 30 may be provided on the outside of the fuel tank 100, i.e., the fuel supply line 40 between the fuel tank 100 and the internal combustion engine 60, as shown in FIG. 8, may be provided in the inside of the fuel tank 100, i.e., in the fuel supply line 40 between the fuel pump module 10 and the fuel tank 100, or as shown in FIG. 9, may be provided in the inside of the fuel pump module 10 to surround the outside of the fuel pump 11.

The secondary filter 30 may be mounted at points shown in FIGS. 7, 8, and 9 so as to be secured from vibrations and impacts caused due to the travelling of a vehicle independent of the type of fuel, the driving conditions of a vehicle and to easily perform the maintenance of a vehicle or may be mounted at any one point selected from the points shown in FIGS. 7, 8, and 9.

In addition, as shown in FIGS. 7, 8, and 9, one secondary filter 30 may be mounted at a specific point or a plurality of secondary filters 30 may be mounted to be connected in parallel.

Meanwhile, the fuel inlet 12 of the fuel pump 11 mounted in the reservoir 15 is provided with the primary filter 16.

The primary filter 16 serves to remove the foreign materials 70 included in the fuel like the secondary filter 30 and is mounted in the fuel inlet 12 of the fuel pump 11 to remove the foreign materials 70 from the fuel sucked into the fuel pump 11.

As described above, the fuel supplied to the internal combustion engine 60 through the fuel pump module 10 removes the foreign materials 70 included in the fuel by passing through the secondary filter 30, the primary filter 16, or the like. As such, clean fuel from which the foreign materials 70 are removed is consumed about 15% to 70% in the internal consumption engine 60 and the remaining fuel is directly returned to the fuel pump 11 through a bypass tube 20 connecting the fuel return line 50 to the fuel pump 11 via the fuel return line 50.

The fuel returned from the internal combustion engine 60 is directly returned to the fuel pump 11 through the bypass tube 20 connecting to the fuel return line 50 to the fuel pump 11. As a result, since the fluid introduced into the fuel pump 11 includes most filtered fuel, clean fuel is supplied to the fuel pump 11 and since the use of the primary filter 16 is reduced, the durability of the primary filter 16 is increased and the durability of the fuel pump 11 is increased.

In addition, the returned fuel serves as a working fluid to suck the fuel within the reservoir 15, thereby making it possible to reduce the fuel amount sucked into the fuel tank 100.

The fuel return line 50 or the bypass tube 20 is provided with a regulator 25 to control the pressure of fuel.

As described above, the regulator 25 may be mounted in the fuel return line 50 or the bypass tube 20, but may be preferably mounted at the connection portion in which the fuel return line 50 and the bypass tube 20 are connected to each other, in consideration of productivity and production convenience.

The fuel supply system having the above-mentioned configuration prevents the fuel in the reservoir 15 from being waxing by directly returning the fuel heated by the internal combustion engine 60 to the fuel pump 11 to more facilitate the fuel sucking process, thereby improving the durability of the fuel pump module 10, including the fuel pump 11.

According to another exemplary embodiment of the present invention, FIGS. 10 to 12 show the fuel supply system of the type in which the fuel supply system and the fuel return line 50 shown in FIGS. 7 to 9 changes their positions. The exemplary embodiment of the present invention are the same configuration other than only the configuration of the fuel return line 50 and therefore, the configuration not mentioned in the exemplary embodiment of the present invention depends on the above-mentioned exemplary embodiments.

That is, FIGS. 10 to 12 show the fuel supply system having various types according to the position of the secondary filter 30 provided on the fuel supply line supplying the fuel from the fuel tank 100 to the internal combustion engine 60. As shown in FIGS. 10 to 12, the fuel supply system of the present invention is configured to include the fuel pump module 10 mounted in the fuel tank 100 stored with the fuel to suck the fuel in the fuel tank 100 and uniformly supply it to the internal combustion engine 60, the fuel supply line 40 connected to the fuel pump module 10 to move the fuel to the internal combustion engine 60, and the fuel return line 50 included in the fuel tank 100 and having one end connected to the fuel supply line 40 and the other end connected to the reservoir 15. That is, the remaining fuel after being supplied to the internal combustion engine 60 is again returned to the reservoir 15 from the fuel tank 100.

Due to the above-mentioned fuel return line 50, the length of the fuel return line 50 is reduced, thereby making it possible to lower the manufacturing costs, increase the convenience of manufacturing, and secure the space.

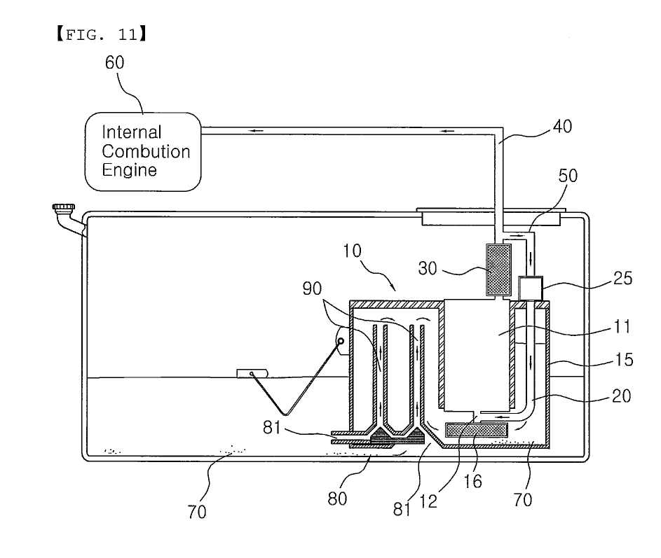

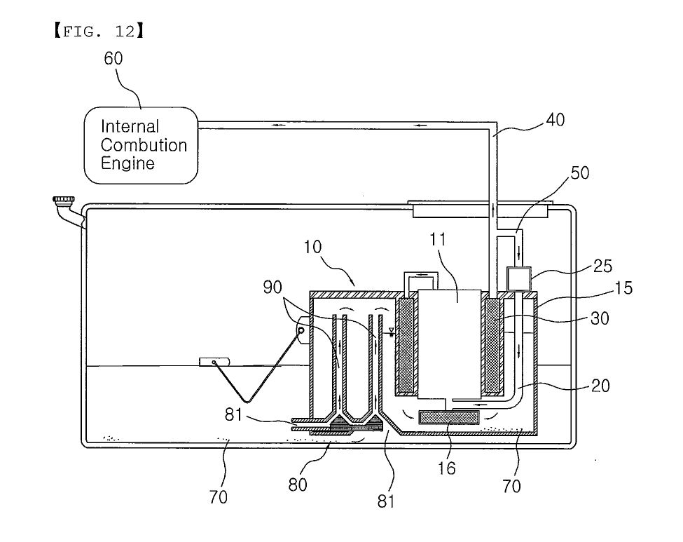

The secondary filter 30 included in the fuel supply line 40 removes the foreign materials 70 included in the fuel to supply more clean fuel to the internal combustion engine 60. As shown in FIG. 10, the secondary filter may be provided on the outside of the fuel tank 100, i.e., on the fuel supply line 40 between the fuel tank 100 and the internal combustion engine 60. As shown in FIG. 11, the secondary filter may be provided in the fuel tank 100, i.e., on the fuel supply line 40 between the fuel pump module 10 and the fuel tank 100. As shown in FIG. 12, the secondary filter 30 may be provided in the fuel pump module 10 to surround the outside of the fuel pump 11. The secondary filter 30 may be disposed at various locations as can be appreciated from the above-mentioned configuration. The secondary filter 30 is disposed at the front end of the fuel return line 50 to return the filtered fuel passing through the secondary filter 30 through the fuel return line 50 (except for the case where the secondary filter 30 is provided at the outside of the fuel tank 100).

In addition, the secondary filter 30 may be mounted at points shown in FIGS. 10, 11, and 12 so as to be secured from vibrations and impacts caused due to the travelling of a vehicle independent of the type of fuel, the driving conditions of a vehicle and to easily perform the maintenance of a vehicle or may be mounted at any one point selected from the points shown in FIGS. 10, 11, and 12.

In addition, as shown in FIGS. 10, 11 and 12, one secondary filter 30 may be mounted at a specific point or a plurality of secondary filters 30 may be mounted to be connected in parallel.

In this case, the fuel supplied to the internal combustion engine 60 through the fuel pump module 10 removes the foreign materials 70 included in the fuel by passing through the secondary filter 30, the primary filter 16, or the like. As such, clean fuel from which the foreign materials 70 are removed is consumed about 15% to 70% in the internal consumption engine 60 and the remaining fuel is directly returned to the fuel pump 11 through a bypass tube 20 connecting the fuel return line to the fuel pump 11 via the fuel return line 50 included in the fuel tank 100.

The effects obtained by the above-mentioned configuration are already described and therefore, the additional description thereof will be omitted.

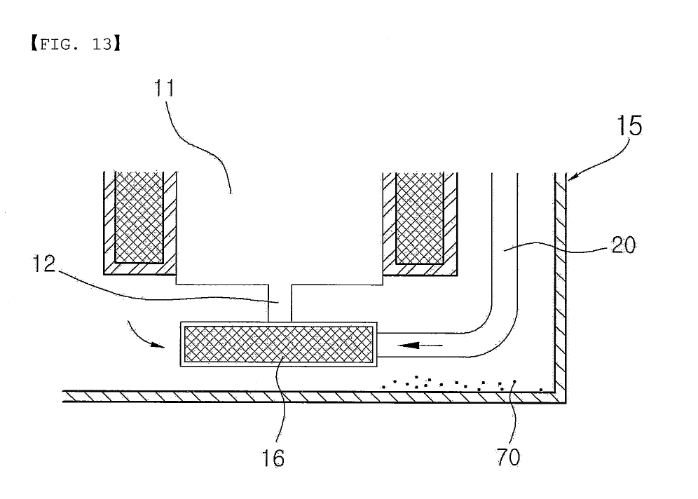

FIG. 13 shows a fuel supply system according to another exemplary embodiment of the present invention. As shown in FIG. 13, the fuel return line 50 through which fuel is returned from the fuel supply line 40 or the internal combustion engine 60 is connected to the fuel pump 11 through the bypass tube 20, such that the clean fuel returned from the fuel supply line 40 or the internal combustion engine 60 is directly returned to the fuel pump 11 through the fuel return line 50 and the bypass tube 20.

In this configuration, the bypass tube 20 may be connected to any one point where the returned fuel is introduced into the fuel pump 11, but may be preferably connected to the rear end of the primary filter 16 mounted in the fuel inlet 12 at the bottom end of the fuel pump 11.

The bypass tube 20 is connected to the rear end of the primary filter 16 mounted in the fuel inlet 12, such that the clean fuel returned from the fuel supply line 40 or the internal combustion engine 60 is directly returned to the fuel pump 11 without passing through the primary filter 16, thereby reducing unnecessary filtering. In addition, the exemplary embodiment of the present invention can be easily applied to the existing fuel supply system by simply replacing and re-mounting the primary filter 16 and the bypass tube 20.

The connection point of the bypass tube 20 is not limited to the above-mentioned exemplary embodiment and any point where the returned fuel can be directly supplied to the fuel pump 11 may be used as the connection point.

The fuel supply system according to the exemplary embodiment of the present invention directly returns the fuel heated by the internal combustion engine to the fuel pump 11 to prevent the fuel in the reservoir 15 from waxing, thereby better facilitating the fuel sucking process. As a result, the durability of the fuel pump 11 and the fuel pump module 10 can be improved.

As set forth above, the exemplary embodiment of the present invention reduces unnecessary filter by re-supplying the clean fuel returned from the internal combustion engine to the internal combustion engine, thereby making it possible to continuously supply clean fuel to the internal combustion engine.

In addition, the exemplary embodiment of the present invention supplies the clean fuel to the internal combustion engine to reduce the trouble of the internal combustion engine due to foreign materials, thereby making it possible to improve fuel efficiency.

In addition, the exemplary embodiment of the present invention can increase the durability of the fuel pump while increasing the durability of the primary filter, by introducing a fluid, i.e., mostly filtered fuel into the fuel pump to reduce a flux sucked into the primary filter.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. However, the present invention is not limited to the specific embodiments and should be construed as including all the changes, equivalents, and substitutions included in the spirit and scope of the present invention.

What is claimed is:

1. A fuel supply system, comprising:
a fuel pump module mounted in a fuel tank and including a reservoir having a predetermined amount of fuel filled therein and a fuel pump mounted in the reservoir to suck the fuel filled in the reservoir and supply it to an internal combustion engine;
a fuel supply line supplying fuel from the fuel pump module to the internal combustion engine; and
a fuel return line returning the fuel from the internal combustion engine to the fuel tank,
wherein the inside of the reservoir is provided with a bypass tube connecting the fuel return line to the fuel pump to directly supply the fuel returned through the fuel return line to the fuel pump through the bypass tube.

2. The fuel supply system of claim 1, wherein the bypass tube is connected to a fuel inlet of the fuel pump.

3. The fuel supply system of claim 1, wherein the fuel inlet of the fuel pump is provided with a primary filter.

4. The fuel supply system of claim 3, wherein the bypass tube is connected to the rear end of the primary filter.

5. The fuel supply system of claim 1, wherein the fuel supply line is provided with a secondary filter.

6. The fuel supply system of claim 5, wherein at least one secondary filter is provided at a point selected from the outside of the fuel tank, the inside of the fuel tank, and the inside of the reservoir.

7. The fuel supply system of claim 1, wherein the fuel return line or the bypass tube is provided with a regulator.

8. A fuel supply system including a fuel pump module mounted in a fuel tank and including a reservoir having a predetermined amount of fuel filled therein and a fuel pump mounted in the reservoir to suck the fuel filled in the reservoir and supply it to an internal combustion engine and a fuel supply line supplying fuel from the fuel pump module to the internal combustion engine, the fuel supply system comprising:
a fuel return line included in the fuel tank and returning fuel from the fuel supply line to the reservoir; and
a bypass tube disposed in the reservoir and connecting the fuel return line with the fuel pump,
wherein the fuel returned through the fuel return line is directly supplied to the fuel pump through the bypass tube.

9. The fuel supply system of claim 8, wherein the bypass tube is connected to a fuel inlet of the fuel pump.

10. The fuel supply system of claim 8, wherein the fuel inlet of the fuel pump is provided with a primary filter.

11. The fuel supply system of claim 10, wherein the bypass tube is connected to the rear end of the primary filter.

12. The fuel supply system of claim 8, wherein the fuel supply line is provided with a secondary filter.

13. The fuel supply system of claim 12, wherein at least one secondary filter is provided at a point selected from the outside of the fuel tank, the inside of the fuel tank, and the inside of the reservoir.

14. The fuel supply system of claim 8, wherein the fuel return line or the bypass tube is provided with a regulator.
